(19) United States
(12) Patent Application Publication
(10) Pub. No.: US 2020/0136414 A1
(43) Pub. Date: Apr. 30, 2020

(54) WIRELESS CONTROL OF AN ENGINE START AND BATTERY SUPPORT MODULE

(71) Applicant: Ioxus, Inc., Oneonta, NY (US)

(72) Inventors: Daniel Alexander Patsos, Canajoharie, NY (US); Joseph D. Agrelo, II, Ballston Spa, NY (US)

(21) Appl. No.: 16/667,458

(22) Filed: Oct. 29, 2019

Related U.S. Application Data
(60) Provisional application No. 62/752,811, filed on Oct. 30, 2018.

(51) Int. Cl. H02J 7/00; G06F 3/044; G08C 17/06

(52) U.S. Cl. CPC H02J 7/0063; H02J 7/0031; H02J 7/0054; H02J 7/345; G08C 17/06; H02J 2007/0067; G06F 3/044

(57) ABSTRACT

Embodiments of the current disclosure include a module comprising a housing including a pair of terminals configured to electrically couple the module to an electrical system, a plurality of ultracapacitors configured to store a charge, a controller operably coupled to the plurality of ultracapacitors, and a wireless communications circuit configured to wirelessly receive an instruction from an external device to change and/or read an operating state of the module

### CROSS-REFERENCE TO RELATED APPLICATIONS

This application claims priority to and the benefit of U.S. Provisional Patent Application No. 62/752,811, filed on Oct. 30, 2018, entitled, “WIRELESS CONTROL FOR ENERGY STORAGE SYSTEM,” the disclosure of which is incorporated herein by reference in its entirely.

### FIELD OF THE DISCLOSURE

Embodiments of the current disclosure are directed toward an engine start and battery support module, and more particularly, apparatus, methods and systems for a wireless control of the engine start and battery support module.

### BACKGROUND

Energy modules can be difficult to monitor or adjust once assembled. For example, modules can be difficult to access depending on the installation locations, such as under a motor vehicle or deep within an engine compartment, can make reaching the controls of the modules an exceedingly difficult task. Wiring the energy modules may introduce their own difficulties such as variable wire harness length requirements for each installation, sealing requirements for connectors, risk of mechanical damage at connection points, and increased cost of materials and installation of the modules.

### SUMMARY

Some embodiments of the present disclosure include a module comprising: a housing including a pair of terminals configured to electrically couple the module to an electrical system; a plurality of ultracapacitors electrically coupled together and configured to store a charge, the plurality of ultracapacitors disposed within the housing; a controller operably coupled to the plurality of ultracapacitors and disposed within the housing; and a wireless communications circuit, operably coupled to a controller, configured to wirelessly receive an instruction from an external device to change and/or read an operating state of the module.

Some embodiments of the present disclosure include a method comprising the steps of receiving, at a wireless communications circuit of a wireless control module, an instruction from an external device to change and/or read an operating state of the control module, the wireless control module including a plurality of ultracapacitors and enclosed within a housing that includes a pair of terminals for electrically coupling the wireless control module to an electrical system; and opening or closing, in response to the received instruction, a safety switch disposed between the plurality of ultracapacitors and the pair of terminals.

In some embodiments, the external device includes a smartphone, a smartwatch, and/or a tablet computing device. In some embodiments, the external device includes an in-vehicle control panel including a touchscreen. In some embodiments, the instruction includes an instruction to change (a) an operating mode to a maintenance mode, (b) the operating mode to the maintenance mode, and the controller causes the module to be rendered electrically safe, and/or (c) an operating mode from a first operating mode to a second operating mode for a pre-determined duration. In some implementations, the instruction to change the operating mode from the first operating mode to the second operating mode for a pre-determined duration automatically reverts back to the first operating mode. In some embodiments, the instruction is sent by the external device to the wireless communications circuit in response to information transmitted to the external device and/or a cloud storage system by the wireless communications circuit, the information being related to a health of the vehicle battery and/or the vehicle.

In some embodiments, the housing is hermetically sealed. In some embodiments, the module further comprises an interface for coupling to an in-vehicle control panel configured to receive the instruction. In some embodiments, the module further comprises a safety switch operably connected to the controller, the safety switch configured to permit or to inhibit electrical communication between the plurality of ultracapacitors and the pair of terminals in response to the received instruction.

Some embodiments of the present disclosure include a system for regulating jump-starting a vehicle, the system comprising: a wireless communications circuit configured to wirelessly receive an instruction from an external device to automatically jump-start the vehicle upon fulfillment of a condition for automatically jump-starting the vehicle; a sensor configured to generate a signal indicating an occurrence, after the wireless receipt of the instruction by the wireless communications circuit, of user engagement with the vehicle; and a controller configured to override the instruction upon receiving the signal from the sensor.

In some embodiments, the system may further comprise a second sensor configured to generate a second signal upon measuring a vehicle environmental parameter satisfying the condition. In some implementations, the second sensor may be a temperature sensor and the condition may be a measurement of a temperature by the temperature sensor failing to exceed a threshold temperature.

In some embodiments, the occurrence of the user engagement includes a turn of an ignition key of the vehicle. Further, the occurrence of the user engagement can be identified based on a voltage change and/or a current change in a bus of the vehicle sensed by the sensor. In addition, the occurrence of the user engagement can be identified based on data on a movement of the vehicle collected by the sensor.

Some embodiments of the present disclosure include a method for regulating jump-starting a vehicle, such a method including the steps of wirelessly receiving, at a wireless control module configured to support the battery of the vehicle, an instruction to automatically jump-start the vehicle upon fulfillment of a condition for automatically jump-starting the vehicle; determining an occurrence, after the wireless receipt of the instruction by the wireless control module, of user engagement with the vehicle; and overriding, based on the determination of the occurrence of the user engagement, the instruction to automatically jump-start the vehicle. In some embodiments, the fulfillment of the condition includes a temperature measurement by a temperature sensor failing to exceed a temperature threshold. In some embodiments, the occurrence of the user engagement (a) includes a turn of an ignition key of the vehicle, and/or (b) the occurrence of the user engagement can be identified based on data on a movement of the vehicle.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is an example block diagram illustrating an engine start and battery support module that includes a wireless communications circuit and is coupled to the battery of a vehicle, according to some embodiments.

FIG. 2 shows an exemplary circuit diagram illustrating an overall master architecture for an engine start and battery support module, according to some embodiments.

FIGS. 3A-B show snapshot images of an exemplary wireless communications circuit for use in an engine start and battery support module, according to some embodiments.

### DETAILED DESCRIPTION

Ultra-capacitor (UC)-based engine start and battery support modules (referred hereafter simply as “modules”) are energy storage systems that can be used to assist a vehicle battery system during engine start-up sequence, in particular when the vehicle battery may be distressed due to adverse weather or engine conditions, or frequent start-stop cycles. The module can also be used to support the “hotel load” of vehicles. The term “hotel load” refers to non-driving energy demands on vehicles, such as energy use for lights, air conditioning, heating, computers, tracking systems, safety systems, and/or the like. Once the engine is started, in some embodiments, the vehicle's alternator/generator can be used to generate electricity and thus recharge the ultra-capacitors. Details of various embodiments of the module are disclosed in PCT International Patent Application No.: PCT/US2015/033743, filed Jun. 2, 2015, entitled “Engine Start and Battery Support Module,” which is incorporated herein by reference in its entirety.

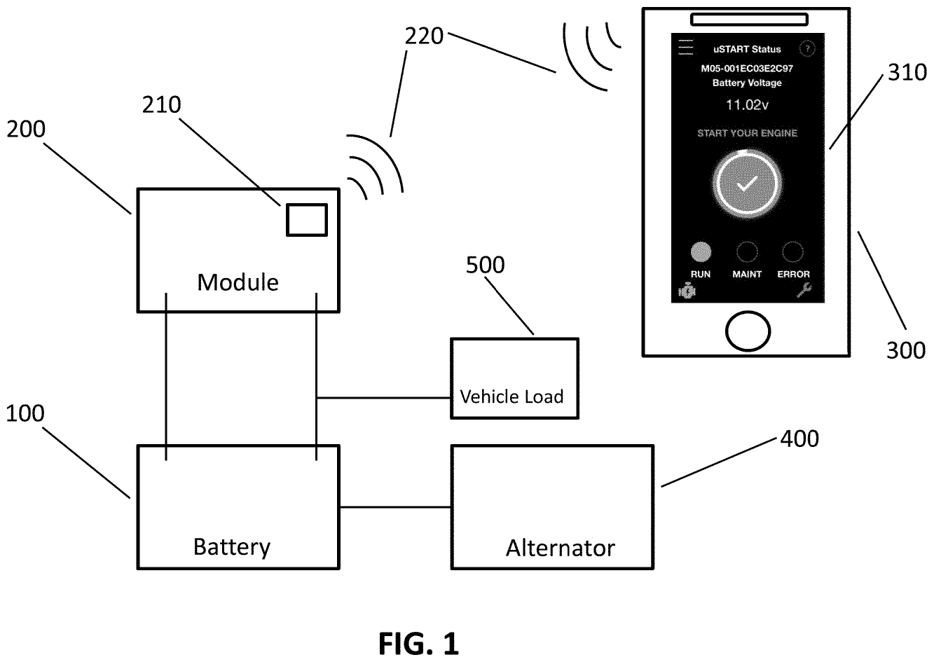

FIG. 1 shows an example of a block diagram illustrating a control module including a wireless communications circuit and is coupled to the battery of a vehicle, according to some embodiments. When a vehicle is off, in some embodiments, the vehicle load 500 (e.g. a hotel load) may be serviced by the battery 100, which can result in the battery 100 being depleted and potentially not having enough power to support an engine start-up sequence later. In some embodiments, even if the alternator 400 charges the battery 100 when the vehicle is on, the battery 100 may still not be capable of supporting an engine start-up sequence or the hotel load, if, for example, the battery is damaged or worn out. In such embodiments, the wireless control module 200 can be used to either supplement the battery 100 or entirely replace traditional lead acid batteries. In some embodiments, the wireless control module 200 may be electrically coupled to the battery, the alternator, and/or DC bus of the electrical system.

In some embodiments, the wireless control module 200 may be electrically coupled to the battery 100, the DC bus of the electrical system and/or the alternator 400. In some embodiments, the wireless control module 200 may monitor the state of the battery 100 and/or the bus of the vehicle for the amount of power available for vehicle operation. For example, the module 200 may monitor the voltage levels on the battery 100 and/or the vehicle bus and, based on the monitored levels, attempt to maintain a proper level of voltage in the vehicle and/or bus. For example, the module 200 may assist the battery 100 to regain a higher voltage level by automatically jump-starting the vehicle. In addition or alternatively, the module 200 may communicate an alarm to an outside system regarding the low voltage or power levels.

In some embodiments, the wireless control module 200 may be configured to cause the recharging of ultracapacitors located within the module by drawing power from the battery 100. For example, the module 200 may monitor the state of the alternator 400 (e.g., determine the alternator is not running) and proceed with recharging the ultracapacitors of the module using power from the battery 100. In some implementations, the module 200 may limit the power that may be drawn from the battery 100 so as not to lower the power or energy level in the battery below some threshold value (e.g., about 9V).

In some embodiments, the wireless control module 200 includes a communications circuit 210 configured for wireless, bi-directional communication with an external device, e.g. smart device 300. In some embodiments, the communications circuit can be used to transmit messages from the module 200 to a smart device 300, such as the aforementioned alarm about low voltage levels in the battery 100 or the vehicle bus. In some embodiments, the module 200 may be configured to receive messages or instructions from the smart device 300. This can be particularly useful when a user may not have ready access to the control module 200, such as when the module 200 is in a moving vehicle or when the user wishes to have access to the controls of the module 200, which may be hermetically sealed and may not have any external connections except for power terminals.

For example, the controls of the module 200 may be configured to be adjusted based on the module installation environment, or the installation requirements may have been changed after installation. In such embodiments, the communications circuit 210 can be used to receive instructions from the smart device 300 to adjust the module controls as needed. Examples of module controls that can be adjusted remotely by the smart device 300 using the communications circuit 210 of the module 200 include parameters such as, but not limited to, limits on input voltage, output voltage, current and power, module ultracapacitor charge limits (e.g., minimum, maximum), operational modes, time thresholds for changing or selecting the modes (e.g., automatically), fault limits and clearing, user permissives, operational data records, maintenance intervals, and wireless communication settings.

In some embodiments, the wireless control module may use parameters to define set points and thresholds for logic control. In some implementations, the parameters may be adjustable. For example, if a behavior is not triggered as expected during an event, the parameters can be adjusted so that the behavior is reliably repeated. As a non-limiting illustrative example, a vehicle alternator could output a lower voltage than expected, preventing the charging of ultracapacitors. In such situations, the input voltage threshold for charging the ultracapacitors can be adjusted to facilitate the charging of the ultracapacitors. For example, the input voltage threshold can be lowered to allow the charging of the ultracapacitors at least almost always when the alternator is running. As another example, in some implementations, a duration set by a timer for putting the wireless control module in low power sleep state may be too short for the periods between vehicle starts. In such implementations, the duration may be adjusted (e.g., increased) accordingly so that the wireless control module would not enter the low power sleep mode too often.

In some embodiments, as noted above, the wireless control module 200 may be hermetically sealed and may not be readily accessible for visual identification, inspection, maintenance, control adjustments, etc. In such embodiments, the wireless communications circuit 210 of the module 102 can be utilized to accomplish these and other tasks. For example, a user with the smart device 300 (on which is executing an application 310) may wirelessly communicate with the control module 200 (and wireless communications circuit 210) to inquire about the status of the module 200 to receive the module's identifying information (such as but not limited to name, serial number, model, etc.). In some embodiments, the information transmitted by the communications circuit 210 to the smart device 300 may be dynamic, i.e., it may be real time or nearly real time, and the information may include status on the capabilities and health of the module 200, the battery 100, the vehicle itself, as well as warnings if the health indications warrant notification to the user of the smart device 300. For example, the module may be monitoring the battery 100 and/or the vehicle bus, and the transmitted information may include the amount of power or energy stored or left in the module 200, the voltage in the battery 100 or the vehicle bus, etc. In such embodiments, the communications circuit 210 may transmit a message or warning to the smart device 300 based on the monitored or measured values (e.g., if these measurements are below some user-defined thresholds). In some embodiments, the module 200 may be connected to a cloud via the wireless communications circuit 210 to, amongst other things, store data collected from the vehicle and parts thereof.

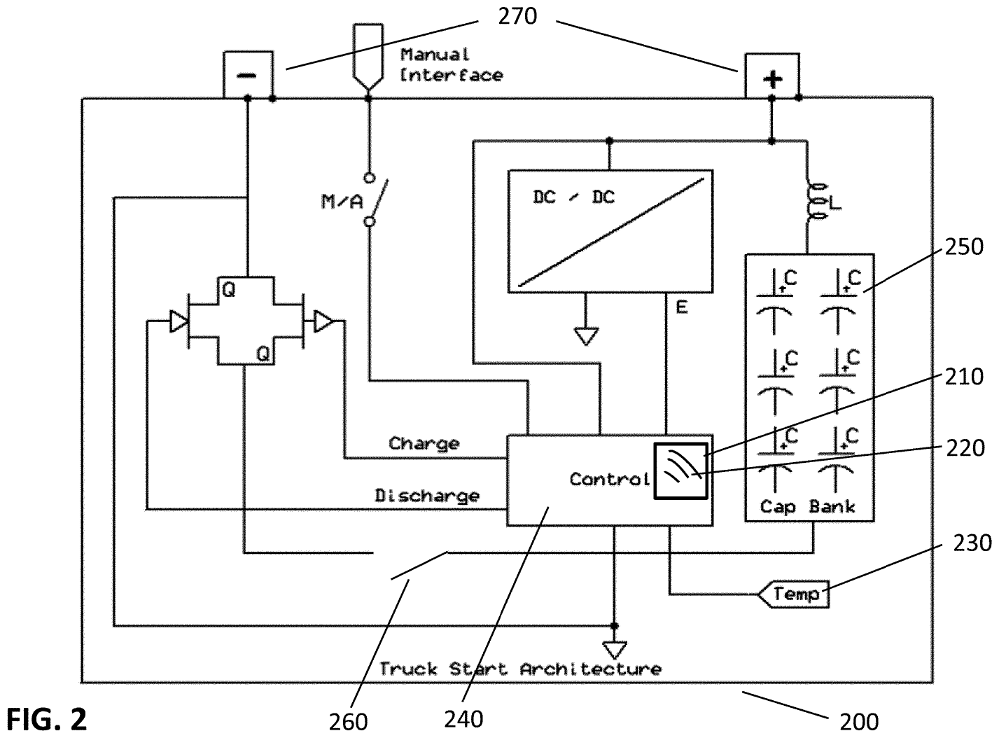

In some embodiments, the module 200 may select which operational modes to operate in based at least partially on the state of the vehicle and/or the module 200 itself. In some embodiments, the wireless communications circuit 210 may be configured to receive instructions from the smart device 300 wirelessly on which operational modes to operate in. Examples of the operational modes include one or more of a maintenance mode, a run mode, a jump-start mode and an auto jump-start mode. During the maintenance mode, in some embodiments, the wireless control module 200 may be placed in a condition that would not cause harm to technicians that are working on the vehicle. When the module 200 is operating in a maintenance mode, in some implementations, the controller may be configured to cause the module to be rendered electrically safe. For example, the module 200 or the ultracapacitors 250 thereof, may be disabled for the duration of the maintenance. In some instances, this may occur by opening a safety switch 260 that lies between the ultracapacitors 250 and the terminals 270 of the wireless control module 200 as shown, for example, in FIG. 2. In some implementations, the instructions for disabling or deactivating the module 200 or the capacitors 250 may be received wirelessly by the wireless communications circuit 210 from the smart device 300. For example, a user (e.g., technician, driver, etc.) using the smart device 300 may send an instruction to the wireless communications circuit 210 to open the safety switch 260. The controller 240, which may be coupled to the wireless communications circuit 210, may then receive the instructions and cause the opening of the safety switch 260 in response to the received instructions, disconnecting the ultracapacitors 250 from the terminals 270, thereby enhancing the safety of technicians maintaining the vehicle or its components. In some instances, the instructions may include details on the conditions of the deactivation, such as the length of the duration, the timing of the deactivation, etc.

In some embodiments, the controller 240 includes a microprocessor, a memory, and a memory bus for facilitating communication between the microprocessor and the memory. In some implementations, the controller 240 may also include a memory controller to manage the flow of data to the memory. In some embodiments, the microprocessor may include a processor core and registers. The processor core can include an arithmetic logic unit, a floating point unit, a signal processing core and/or the like.

In some embodiments, the memory can be of any type including but not limited to volatile memory and/or non-volatile memory. Non-limiting examples of the memory include read only memory (ROM), random access memory (RAM), erasable programmable memory (e.g., EPROM and EEPROM), flash memory, and/or optical/magneto-optical storage media. In some implementations, the memory can include the operating system of the controller, applications and/or program data such as buffer addresses, etc. An application can include software and/or processes encoded in algorithms for executing at least some functions of the controller, such as disconnecting the ultracapacitors 250 from the terminals 270, cause the opening of the safety switch 260, etc.

In some embodiments, the wireless communications circuit 210 includes a transmitter and/or a receiver configured to transmit and/or receive wireless signals, respectively. In some implementations, the communications circuit 210 may include a transceiver that is capable of both transmitting and receiving wireless signals. In some implementations, the wireless communications circuit may be configured to provide wireless data connections such as, but not limited to, a Wi-Fi® access point, a Bluetooth® connection, a short range radio frequency identifier (RFID) transmitter/receiver, etc. In some embodiments, the transmitter and/or the transceiver can include an antenna configured to transmit or emit wireless signals. In some embodiments, the receiver and/or the transceiver can include an antenna configured to receiver wireless signals. In such embodiments, the transmitter, the receiver and/or the transceiver may be configured to communicate using signals that have frequencies within any suitable range.

In some embodiments, the vehicle may be running several short hauls in a limited duration of time, resulting in a large number of engine starts per day. In such embodiments, the module 200 may operate in a run mode where the module 200 assists the battery 100 by servicing the “hotel load” 500 of the vehicle. For example, the vehicle may be making several delivery stops, and the module 200 may support the vehicle's “hotel load” 500 so that the battery 100 may not be too depleted to re-start the vehicle.

In some embodiments, the vehicle may not in fact start on the first try, and the module 200 may be used to jump-start a vehicle. For example, a user of the wireless control module 200 (such as a driver) may engage the module 200 remotely via the wireless communications circuit 210 to jump-start the vehicle. Using a smart device 300 such as a tablet, a smartwatch, a smartphone, etc., having executing thereon an application 310 configured to communicate with the wireless communications circuit 210, in some embodiments, the user/driver can jump-start the vehicle without a need for a jump-start cable and external power source such as the battery of another vehicle (as is traditionally done during jump-starting). In some embodiments, the user/driver may use a manual interface coupled to the wireless control module 200 to cause the module 200 to jump-start the vehicle. That is, the smart device 300 may be an in-vehicle control panel including a touchscreen providing drivers/vehicle occupants access to wireless communication with the module 200, including before, during and/or after operating the vehicle.

In some embodiments, to jump start the vehicle, the wireless control module 200 may first attempt to trickle charge its ultracapacitors from the weak battery 100 in order to store more energy for the next vehicle starting attempt. Power can be supplied back to the vehicle after the ultracapacitors are charged sufficiently or when the battery can no longer support trickle charging.

In some embodiments, the jump-starting of the vehicle by the module 200 may occur automatically. For example, the module 200 may be monitoring the voltage levels on the battery 100 and/or the vehicle bus during a stop, and determine that the level is too low to allow for the re-start of the vehicle. In such embodiments, the module 200 may jump-start the vehicle without necessarily being instructed to do so wirelessly or otherwise by a user/driver. For example, this may occur when the module 200 detects an attempt to start the vehicle, e.g., by a turn of the ignition key or voltage measurement by a voltage meter. As another example, this may occur when the wireless control module 200 detects, with the use of a temperature sensor 230, that the temperature is below some threshold (indicating that the battery voltage was also too low). In some implementations, low ultracapacitor voltage can be a trigger condition for automatically jump starting a vehicle, as low ultracapacitor voltage increases the difficulty in starting a vehicle. This follows because, in some implementations, ultracapacitor power is proportional to voltage and ultracapacitor energy is proportional to voltage squared.

In some embodiments, the wireless communications between the smart device 300 and the wireless communications circuit 210 can be accomplished via various frequency bands, modulation, and protocols. For example, the communications circuit 210 may be a Bluetooth® or Wi-Fi transceiver configured to communicate using, respectively, Bluetooth® protocols or Wi-Fi standards (e.g., IEEE 802 standards), in the frequency band ranging from about 2.4 GHz to about 2.5 GHZ, from about 5.1 GHz to about 5.9 GHz, including values and subranges therebetween. In some embodiments, the use of a Bluetooth® or Wi-Fi® communications system facilitates the standardization of the communication 220 between the module 200 and an external smart device 300 such as a smartphone, a tablet or a smartwatch. Such capability to use ubiquitous smart devices 300 as control interfaces to control the parameters of the module 200 can be beneficial as there would be little or no need to develop and install additional hardware to interface with the module's 200 controls once the module 200 is installed (e.g., installed in a difficult to access location or hermetically sealed after installation). Further, new software features can be added to the control interface (e.g., application 310) overtime as desired.

FIG. 2 shows an example of a circuit diagram illustrating an overall master architecture for the wireless control module disclosed herein, according to some embodiments. In some embodiments, the module 200 may be configured to modulate the transfer of energy between the UCs 250 and the system battery 100 in both directions, and in some instances, the transfer of energy may be based on pre-determined parameters, and/or thresholds thereof. Examples of said parameters and/or thresholds include vehicle DC bus loads, starter motor sizes, battery age, wiring conditions, battery conditions, battery quantity, accessories, starter type, starter age, battery type, temperature, experience of the driver, etc. In such embodiments, the architecture may allow a user utilizing an external smart device (such as 300 in FIG. 1) with an application 310 executing thereon to adjust the parameters and/or threshold as desired. For example, the module may include a wireless communications circuit 210 configured to receive instructions from the smart device 300 to vary the dependence of the transfer of energy on one or more of the noted parameters/thresholds. For instance, after receiving information on the age/condition of the battery 100 from the wireless control module 200 via the communications circuit 210, in some embodiments, the user may adjust the voltage thresholds for the module 200 to draw energy from the battery 100 so as not to damage the battery 100. An example of such a threshold may be about 9V.

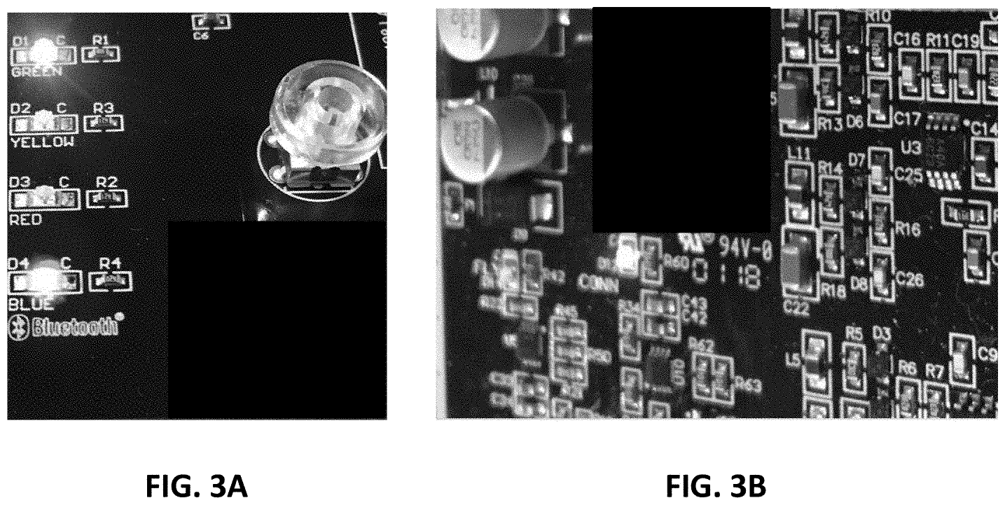

As another example, the module 200 may recognize when to deliver charge to keep the battery 100 alive for short stops without the engine running. In such embodiments, the pre-determined parameter may be the voltage level in the battery 100 and/or the vehicle bus, the number of engine stops and starts, the duration of the stops, etc. In some embodiments, the wireless control module 200 allows for independent and/or remote adjustments of the pre-determined parameters such as the voltage levels at which hotel loads and engine starts are supported, thus providing for variable energy delivery depending on the specific application and/or exact installation. In some embodiments, the wireless communications circuit 210 may be configured to receive parameter adjustment instructions from an external smart device 300 such that the controller 240 of the wireless control module 200 may adjust the parameters or thresholds of the module 200 according to the instructions. For example, the wireless communications circuit 210 may receive instructions wirelessly from the smart device 300 adjusting the limits on the input/output voltages of the battery 100. In some embodiments, the instructions may include input voltage thresholds so as to not ruin an otherwise depleted battery 100 (e.g., when energy is being drawn from the battery 100 to charge up the UCs 250 of the module 200), control both the input and output current to be able to charge nearly empty UCs 250, and/or control a variable output voltage set point in order to control the energy stored on the bank of UCs 250 as temperature varies. FIGS. 3A-B show snapshot images of an example wireless communications circuit for use in a wireless control module 200, according to some embodiments.

In some embodiments, the charge level of the UCs 250 may depend on temperature and a user may be able to adjust the relationship between the charging and the temperature wirelessly with the use of a smart device 300. For example, each UC 250 may be configured to be charged to a predetermined level of per cell voltage, an example of which includes about 2.7 V/cell. In some embodiments, the per-cell voltage value may be shifted automatically higher (e.g., 3.0 V/cell) when a low temperature is reached (e.g., 0° F.) and even higher per-cell voltage (e.g., 3.3 V/cell) when the temperature falls even lower (e.g., below −20° F.). In some embodiments, the level of per-cell charging as a function of temperature may be adjusted by a user utilizing a smart device 300 by sending instructions to the wireless communications circuit 210 of the wireless control module 200. For example, in embodiments where the temperature is lower than usual or normally expected, the user may instruct the module remotely via the communications circuit 210 to charge the UCs to an even higher per-cell voltage. In other words, the total voltage on the bank of UCs 250 may be actively adjusted upwards or downwards depending on some parameter of interest, including the temperature in the module (e.g., as measured by a temperature sensor 230) and such adjustment can be made wirelessly by a smart device 200 using the wireless communications circuit 210, as discussed above for example. In some embodiments, data related to the engine (e.g., battery or module charge or voltage levels, module or engine temperature values, etc.) may also be transmitted by the wireless control module 200 to the smart device 300 via the communications circuit 210.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of the present technology may be implemented using hardware, firmware, software or a combination thereof. When implemented in firmware and/or software, the firmware and/or software code can be executed on any suitable processor or collection of logic components, whether provided in a single device or distributed among multiple devices.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A module, comprising:
a housing including a pair of terminals configured to electrically couple the module to an electrical system;
a plurality of ultracapacitors electrically coupled together and configured to store a charge, the plurality of ultracapacitors disposed within the housing;
a controller operably coupled to the plurality of ultracapacitors and disposed within the housing; and
a wireless communications circuit, operably coupled to a controller, configured to wirelessly receive an instruction from an external device to change and/or read an operating state of the module.

2. The module of claim 1, wherein the external device includes a smartphone, a smartwatch, and/or a tablet computing device.

3. The module of claim 1, wherein the external device includes an in-vehicle control panel including a touchscreen.

4. The module of claim 1, wherein the instruction includes an instruction to change an operating mode to a maintenance mode.

5. The module of claim 1, wherein the instruction includes an instruction to change the operating mode to the maintenance mode, and the controller causes the module to be rendered electrically safe.

6. The module of claim 1, wherein the instruction includes an instruction to change an operating mode from a first operating mode to a second operating mode for a pre-determined duration.

7. The module of claim 6, wherein the instruction to change the operating mode from the first operating mode to the second operating mode for a pre-determined duration automatically reverts back to the first operating mode.

8. The module of claim 1, wherein the housing is hermetically sealed.

9. The module of claim 1, wherein the instruction is sent by the external device to the wireless communications circuit in response to information transmitted to the external device and/or a cloud storage system by the wireless communications circuit, the information being related to a health of the vehicle battery and/or the vehicle.

10. The module of claim 1, further comprising:
an interface for coupling to an in-vehicle control panel configured to receive the instruction.

11. The module of claim 1, further comprising:
a safety switch operably connected to the controller, the safety switch configured to permit or to inhibit electrical communication between the plurality of ultracapacitors and the pair of terminals in response to the received instruction.

12. A method, comprising:
receiving, at a wireless communications circuit of a wireless control module, an instruction from an external device to change and/or read an operating state of the control module, the wireless control module including a plurality of ultracapacitors and enclosed within a housing that includes a pair of terminals for electrically coupling the wireless control module to an electrical system; and
opening or closing, in response to the received instruction, a safety switch disposed between the plurality of ultracapacitors and the pair of terminals.

13. The method of claim 12, wherein the external device includes a smartphone, a smartwatch and/or a tablet computing device.

14. The method of claim 12, wherein the instruction includes the instruction to change the operating mode from a first operating mode to a second operating mode for a pre-determined duration before reverting back to the first operating mode.

15. A system for regulating jump-starting a vehicle, comprising:
a wireless communications circuit configured to wirelessly receive an instruction from an external device to automatically jump-start the vehicle upon fulfillment of a condition for automatically jump-starting the vehicle;
a sensor configured to generate a signal indicating an occurrence, after the wireless receipt of the instruction by the wireless communications circuit, of user engagement with the vehicle; and
a controller configured to override the instruction upon receiving the signal from the sensor.

16. The system of claim 15, wherein the sensor is a first sensor and the signal is a first signal, further comprising a second sensor configured to generate a second signal upon measuring a vehicle environmental parameter satisfying the condition.

17. The system of claim 15, wherein the sensor is a first sensor and the signal is a first signal, further comprising a second sensor configured to generate a second signal upon measuring a vehicle environmental parameter satisfying the condition, the second sensor being a temperature sensor and the condition being a measurement of a temperature by the temperature sensor failing to exceed a threshold temperature.

18. The system of claim 15, wherein the occurrence of the user engagement includes a turn of an ignition key of the vehicle.

19. The system of claim 15, wherein the occurrence of the user engagement is identified based on a voltage change and/or a current change in a bus of the vehicle sensed by the sensor.

20. The system of claim 15, wherein the occurrence of the user engagement is identified based on data on a movement of the vehicle collected by the sensor.

21. A method for regulating jump-starting a vehicle, comprising:
wirelessly receiving, at a wireless control module configured to support the battery of the vehicle, an instruction to automatically jump-start the vehicle upon fulfillment of a condition for automatically jump-starting the vehicle;
determining an occurrence, after the wireless receipt of the instruction by the wireless control module, of user engagement with the vehicle; and
overriding, based on the determination of the occurrence of the user engagement, the instruction to automatically jump-start the vehicle.

22. The method of claim 21, wherein the fulfillment of the condition includes a temperature measurement by a temperature sensor failing to exceed a temperature threshold.

23. The method of claim 21, wherein the occurrence of the user engagement includes a turn of an ignition key of the vehicle.

24. The method of claim 21, wherein the occurrence of the user engagement is identified based on data on a movement of the vehicle.
